(19) United States
(12) Patent Application Publication
(10) Pub. No.: US 2007/0117573 A1
(43) Pub. Date: May 24, 2007

(54) System and method for generating geocoded data for network optimization under different network architectures and location technology conditions

(76) Inventors: Joseph P. Kennedy JR., Great Falls, VA (US); Roger K. Alexander, Rockville, MD (US); Thomas B. Gravely, Herndon, VA (US); Andrew Beck, Ashburn, VA (US); Kalpathi Ananthakrishnan, Ashburn, VA (US)

Correspondence Address: DUANE MORRIS, LLP, Suite 700, 1667 K Street, N.W., Washington, DC, 20006, US

(21) Appl. No.: 11/593,063

(22) Filed: Nov. 6, 2006

Related U.S. Application Data
(60) Provisional application No. 60/733,205, filed on Nov. 4, 2005.

(51) Int. Cl. H04Q 7/20

(52) U.S. Cl. 455/456.1

(57) ABSTRACT

A method for generating geocoded data for a wireless communication system works over a plurality of network architectures and location processes. The method identifies the presence of mobile activity in the wireless communication network and in response collects wireless communication measurement data associated with the mobile activity. Geolocation is performed on the mobile associated with the activity and the geolocation and measurement data are combined forming geocoded data. The geocoded data is then supplied to a processing system to support implementation of optimization of the wireless network.

### CROSS REFERENCES

This application claims priority benefits of U.S. Provisional Application Ser. No. 60/733,205 titled Producing Geocoded Data for Network Optimization Under Different Network Architecture and Location Technology Conditions filed Nov. 4, 2005 entirety of which is incorporated herewith.

This application is related to and co-pending with U.S. patent application Ser. No. 10/531,042, entitled “Wireless Communication Network Measurement Data Collection Using Infrastructure Overlay-Based Handset Location System” filed on Apr. 12, 2005, the entirety of which is hereby incorporated by reference.

### BACKGROUND

The disclosed subject matter allows geocoded data to be generated from a geo-location overlay network in a host wireless communication system.

The use of wireless communication devices such as telephones, pagers, personal digital assistants, laptop computers, etc., hereinafter referred to collectively as “mobile appliances” or “mobiles”, has become prevalent in today's society. Recently, at the urging of public safety groups, there has been increased interest in technology which can determine the geographic position, or “geo-locate” a mobile appliance in certain circumstances. For example, the Federal Communication Commission (“FCC”) has issued a geo-location mandate for providers of wireless telephone communication services that puts in place a schedule and an accuracy standard under which the providers of wireless communications must implement geo-location technology for wireless telephones when used to make a 911 emergency telephone call (FCC 94-102 E911).

In addition to E911 emergency related issues, wireless telecommunications providers are developing location-enabled services for their subscribers including roadside assistance, turn-by-turn driving directions, concierge services, location-specific billing rates and location-specific advertising.

To support FCC E911 rules to locate wireless 911 callers, as well as the location enabled services, the providers of wireless communication services are installing mobile appliance location capabilities into their networks. In operation, these network overlay location systems take measurements on RF (“Radio Frequency”) transmissions from mobile appliances at base station locations surrounding the mobile appliance, and estimate the location of the mobile appliance with respect to the base stations. Because the geographic location of the base stations is known, the determination of the location of the mobile appliance with respect to the base station permits the geographic location of the mobile appliance to be determined. The RF measurements of the transmitted signal at the base stations may include, but are not limited to, the time of arrival, the angle of arrival, the signal power, or the unique/repeatable radio propagation path (radio fingerprinting) derivable features. In addition, the geo-location systems can also use collateral information, e.g., information other than that derived for the RF measurement to assist in the geo-location of the mobile appliance, for example, location of roads, dead-reckoning, topography, map matching, etc.

In a network-based geo-location system, the mobile appliance to be located is typically identified and radio channel assignments determined by (a) monitoring the control information transmitted on a radio channel or wireline interface that is part of the wireless communication system for telephone calls being placed by the mobile appliance to detect calls of interest, e.g., 911 calls, (b) a location request provided by a non-mobile appliance source, e.g., an enhanced services provider. Once a mobile appliance to be located has been identified and radio channel assignments determined, the location determining system is first tasked to determine the geo-location of the mobile appliance. Then the LDS may directed to report the determined position to requesting entity or enhanced services provider.

The monitoring of the RF transmissions from the mobile appliance or wireline interfaces containing call setup or channel assignment information to identify calls of interest is known as “tipping”, and generally involves recognizing a call of interest being made from a mobile appliance and collecting the call setup information. Once the mobile appliance is identified and the call setup information is collected, the location determining system can be tasked to geo-locate the mobile appliance.

FIG. 1 is a flow chart illustration of a typical geo-location process 100. In the normal course of operation, the Geolocation Control Station (“GCS”) may be tasked by an outside entity to generate a location estimate on a particular mobile appliance in block 110. The tasking typically is accompanied by information on the mobile of interest which may include the serving base station and sector for the call and the RF channel (frequency, time slot, Code Division Multiple Access (“CDMA”) code, etc.) being used by the wireless communications network to complete the wireless connection. Once the GCS receives this tasking, based on the serving sector, it tasks a set of Location Measurement Units (“LMU”) proximate to the serving sector or serving base station to detect the signal from the target mobile appliance in block 120. The set of LMUs determines measurement on the RF emission of the mobile appliance's signal, as indicated by block 130. The LMUs then report the measurements to the GCS. The GCS then computes a location estimate typically using some mathematical or data matching algorithm, as represented in block 140, and reports the estimated location to the requesting entity, as indicated in block 150. In an alternative embodiment, control channels/information on either RF or wireline links used to set up calls in the wireless network can be scanned to detect the placement of a call of interest. The signaling that occurs on the control channel can be used to determine location. Further, RF traffic channel parameters can be extracted from the control channel messaging to determine which traffic channel to use for location related measurements.

Network overly location systems typically locate a mobile appliance on the traffic channels of a wireless network. The systems typically use sensors employing Techniques Of Time Difference Of Arrival (TDOA) supplemented with Angle of Arrival (AOA) in some cases to perform a multi-site location computation and mobile unit assistance. The traffic channel information is provided through a separate process, with one option being a wire line interface providing IS-41 Mobile Information (“MOBINFO”) parameters passed by the Mobile Positioning Center (“MPC”) as part of the J-STD-036 Geo-location Position Request (“GPOSREQ”) message.

Operators of commercial wireless communication networks, as do most network operators, need to determine the performance of their wireless networks to effect repairs, plan expansion and adjudicate customer complaints. The current state of the art for collection of this data is to perform drive testing with a specialized drive test unit comprised of a test mobile telephone, Global Positioning System (“GPS”) receiver, and data storage capability such as a laptop computer. Calls are placed from the test mobile and data is collected from an interface port on the phone. The collected data is composed of information related to the operation of the phone in the wireless network and typically includes received and transmitted power levels, handover status, data transmission quality (e.g., bit error rates, frame error rates), etc., along with location and time stamping. The drive test process produces data on the operation of the test mobile only and signals received at the test mobile. Thus, the performance of the reverse link and its associated merit parameters are not captured. Additionally, a technician is required to perform the drive testing. This prior art method also introduces dedicated calling traffic to the network and results in an additional associated system load. Additional prior art utilizes data collected at a Mobile Switch for these purposes. This method is generally of poor value given that the collected measurements cannot be referenced to a mobile phone actual location, and only to a serving sector (this is the granularity with which the mobile switch knows the location of a mobile).

Geo-location systems, when not being tasked to locate a mobile appliance for emergency or other location-based services, are effectively in an idle mode. The tasking duty cycle can vary depending on what uses are being made of the location data. For E911 purposes, the effective utilization of the location network is low. With other location enabled value added services, the use may be higher, depending on the service. A service providing turn by turn instructions to a motorist would likely be higher than a service that provides road side assistance.

The disclosed subject matter utilizes this excess capacity of the location network to generate geocoded data. An additional embodiment gathers geocoded data on the actual E911 calls, or on any calls being located for other value added services.

Thus, is it an object of the disclosed subject matter to obviate the deficiencies of the prior art and provide in a geo-location system the ability to collect geocoded data. Another benefit of the disclosed subject matter is the ability to operate a continuous background task for network overlay location which does not burden the network.

These objects and other advantages of the disclosed subject matter will be readily apparent to one skilled in the art to which the disclosure pertains from a perusal or the claims, the appended drawings, and the following detailed description of the preferred embodiments.

### BRIEF DESCRIPTION OF THE DRAWINGS

FIG. 1 is a flow chart illustration a prior art geo-location process.

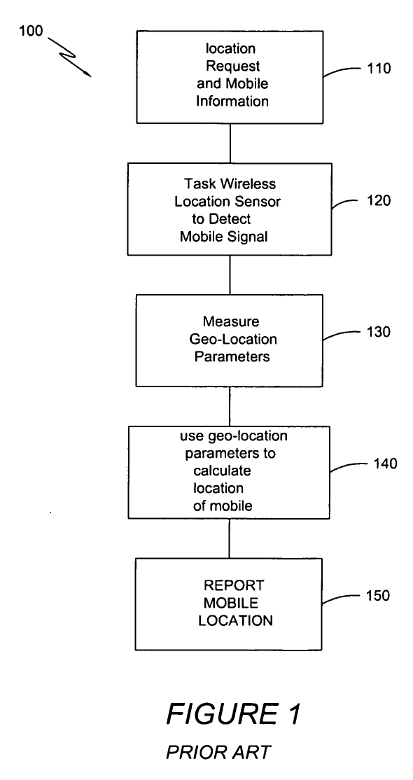

FIG. 2 is a representative schematic of a 2G network as specified in the Third Generation Partnership Project (“3GPP”) standards where the only non-standard element is the Abis Monitoring Unit (“AMU”).

FIG. 3 is a flow chart illustrating a method of generating geocoded data according to embodiments of the disclosed subject matter.

FIG. 4 is a flow chart for generating geocoded data for use in optimizing a network according to embodiments of the disclosed subject matter.

FIG. 5 is a flow chart for generating geocoded data for use in optimizing the network where geolocation data and wireless communication measurement data for an active mobile are determined by separate entities according to embodiments of the disclosed subject matter.

Common elements are identified with similar reference numbers where advantageous.

### DETAILED DESCRIPTION

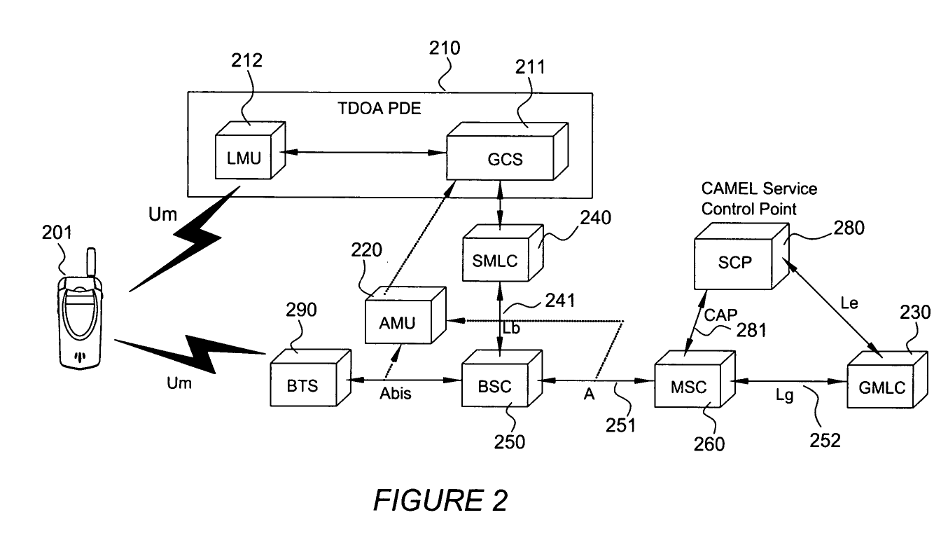

FIG. 2 shows a standard Second Generation (“2G”) network as specified in the 3GPP standards. The only non-standard element is the AMU. As described in co-pending U.S. application Ser. No. 10/531,042, geocoded data generation is accomplished using the AMU to trigger geolocation and to collect network data, and by using the Uplink Time Difference of Arrival (“UTDOA”) position determining equipment (“PDE”) to locate the call.

A brief description for each element/interface as it applies to this present subject matter is presented in FIG. 2. The inclusion and/or exclusion of network elements or interfaces is for illustrative purposes only and is not intended to be exhaustive or limiting.

Time Difference of Arrival Position Determining Equipment (“TDOA PDE”) 210 contains a GCS 211 and LMUs 212. The TDOA PDE 210 is present when UTDOA geolocation is used. In addition to providing geocoding for a particular mobile, the LMU 212 can access network data from the Um interface including from the Slow Associated Control Channel (“SAACH”) message and Mobile Measurement Report (“MMR”) data including Rx quality (timing advance and mobile transmit power) and Rx signal level of serving and neighboring cells. TDOA PDE 210 has knowledge of the mobile's serving sector, channel assignment, Temporary Mobile Subscriber identity (“TMSI”), and under limited conditions the International Mobile Equipment Identity (“IMEI”) (although IMEI may also be obtained in a network supporting ciphering by commanding its inclusion through the setting of a Cipher Mode response in the Cipher Mode Command) and also under limited conditions the International Mobile Subscriber Identity (“IMSI”).

The AMU 220 monitors the Abis interface between the Base Station Controller (“BSC”) 250 and the Base Transceiver Station (“BTS”) 290. The AMU 220 may detect a call initiation (time) and serving sector. The serving sector (Cell ID) is derivable from the associated channel on which the Abis data is derived in conjunction with network configuration data. The AMU 220 may also know or be provided the channel assignment data as well as the TMSI of the mobile. The AMU 220 may also know IMEI and IMSI of the mobile under certain conditions and/or network implementations. The AMU 220 also has access to the network data including MMR data. The AMU 220 may also support an interface to an Location Client Services (“LCS”) client for the purposes of triggering mobile-terminated location requests via the Global Mobile Location Center (“GMLC”) 230.

A Serving Mobile Location Center (“SMLC”)/Lb interface 241 (interface between the SMLC 240 and BSC 250) has access to the MMR data (as part of an enhanced cell ID-based and U-TDOA location). The SMLC/Lb interface 241 knows the serving sector and location of the mobile based on the selected location method (TDOA, Assisted Global Positioning System (“AGPS”), Enhanced Observed Time Difference (“EOTD”), etc.). The SMLC/Lb interface 241 also may know channel assignment data if the UTDOA-based location method is used. However, the SMLC/Lb interface 241 is not aware of the identity of the mobile (IMSI, Mobile Station International ISDN Number (“MSISDN”), TMSI or IMEI).

The A 251 and the Lg 252 interfaces and the terminal elements are typically interconnected via an SS7 network. The A interface 251 connects the mobile switching center (“MSC”) 260 to the radio network of the Base Station Controller (“BSC”) 270 while the Lg interface 252 supports interconnection of the MSC 260 to the GMLC 230 location element.

The Le interface 231 connects external location clients 280, for example a Customized Application for Mobile Network Enhanced Logic (“CAMEL”) Service Control Point, to the GMLC 230. The Le interface 231 is used by external clients 280 to request and receive location information. Mobiles 201 may be identified by their MSISDN and IMSI. Additionally, the mobiles may be identified by their IMEI when the IMEI is provided as the mobile identifier in the context of an emergency call location request, in such cases it is used in conjunction with the emergency service routing key (“ESRK”) for routing of the subsequent MT-LR request to the current serving network.

The CAP 281 (CAMEL Application Part) protocol over the SS7 network supports interconnection between the MSC 260 and SCP 280 for intelligent network based triggering of mobile-terminated location requests via the GMLC 230.

High accuracy position location (on the order of less than 100 meters of error) is preferable since this level of accuracy is likely is necessary for geocoded data to have value in network optimization. The choice of location method (made at the SMLC, where implemented) is dictated by the requirement to return a position location within an accuracy (horizontal/vertical) and response time dictated by the Quality of Service (“QoS”) specified in the location request submitted to the GMLC 230 at the Le interface 231. However, similar concepts may apply to lower accuracy location methods.

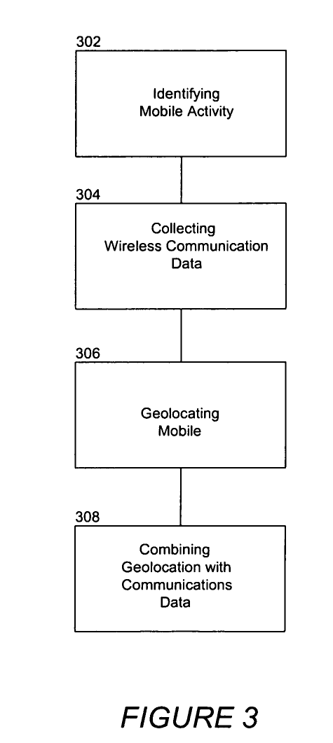

Referring to FIG. 3, a method of generating geocoded data is shown for some embodiments of the disclosed subject matter. The presence of mobile activity is identified in the wireless communication system as shown in Block 302. The presence of mobile activity may be identified, for example, from intelligent network triggers in the network for specific permanent mobile IDs. Additional embodiments may identify the presence of mobile activity from the AMU monitoring of the Abis interface for GSM systems or equivalent monitoring devices used for Universal Mobile Telecommunications System (“UMTS”) such as an Iub monitor or other known system.

Wireless communication measurement data associated with the mobile activity is then collected as shown in Block 304. The collection of radio network measurement data may be accomplished from the radio measurement data passed to the position location server SMLC in a UTDOA system or the measurement data may be collected directly from the radio interface by the LMUs when the position location is being performed. The collecting of wireless communication measurement data by the LMU may be accomplished by direct access to the SACCH via the Um interface and/or by an AMU with access to the SACCH via the Abis interface. The collecting of wireless communication measurement data may also be performed by an interface with a SMLC. The wireless communication measurement data may include timing advance, Signal to Noise Ratio (“SNR”), received signal power, and transmit signal power. Wireless communication measurement data may also include the receiving Cell identification retrievable from an interface with the SMLC.

Geolocation is then performed on the active mobile as shown in Block 306. The geolocation may be performed by any of several methods including UTDOA, AOA, AGPS information received from the mobile, downlink time of arrival information received from the mobile, i.e., EOTD or other known systems or combination of methods. For a geolocation triggered by an intelligent network, the GMLC is accessed to obtain the ID associated with the trigger; whereas, the LMU may capture Mobile Station (“MS”)-originated measurement data while performing the position location function. The geolocation of the mobile and its associated channel assignment may be performed by UTDOA PDE, and information regarding the mobile may be received by the UTDOA PDE from the AMU. Information regarding the mobile may also be received by the UTDOA PDE from an SMLC.

The geolocation and the communication measurement data may then be combined to form geocoded data as shown in Block 308. The combining of the geolocation data and the measurement data is enabled by the associated characteristics of each, such as time period method of geolocation, serving sector, LCS client type or other correlated characteristics common to the mobile activity. The method may include time stamping the geolocation measurements and wireless communication measurement data preferably to further aid this correlation. In alternative embodiments the mobile's geolocation and wireless communication measurement data may be linked by common data collection/position determination time at an LMU associated with the UTDOA PDE.

The geocoded data is then transferred to an internal or external processing system to implement network optimization for the wireless communication network as shown in Block 310. The types of optimization enabled by the geocoded data may include but is not limited to reducing voids in coverage, handoff assistance, transmit power regulation and location of network equipment.

The wireless communication measurement data of interest may also include handoff assistance information measured by the mobile and provided to the network to manage site to site handoffs. This data routinely comprises measurement data made by the mobile on neighbor cell sites (typically Received Signal Strength Indicator (“RSSI”) measurements on forward link transmissions from the neighbor cell sites). This data is forwarded to the GCS by the primary LMU. An actual signal sample may also be relayed to the GCS where it is demodulated and decoded as needed or where processing functions are more readily available

Table 1 shows several specific architecture and location technology scenarios to illustrate embodiments of the present subject matter. The embodiments are arranged based on network equipment and location system equipment available. Other embodiments are also envisioned and their exclusion in Table 1 is not intended to be limiting.

TABLE 1

| | | | Infor- | | | | |
|---|---|---|---|---|---|---|---|
| | Network | | mation | Mobile Activity | | | |
| | Location | Location | Access | Determination/ | Radio Measurement | Position Location | Linking Location with Radio |
| S # | Elements | Method | Points | Trigger | Data Collection | Mechanism | Measurement Data |
| 1 | UTDOA | UTDOA | Abis | Mobile activity | Mobile measurement | Cell ID, Channel and | MMR from SAACH and UTDOA |
| | PDE- | | (AMU) | within Cell detected | reports (MMR) | Ciphering information | location derived concurrently by LMU. |
| | LMU, | | Um- | by AMU | obtained from LMU. | sent from AMU to PDE. | AMU provides Mobile and BTS |
| | AMU | | SACCH | | Mobile and BTS | PDE-provided position | synchronized measurement data. |
| | | | (LMU) | | measurement reports | location. | LMU MMR data used to synchronize |
| | | | | | obtained from AMU. | | location with AMU measurement data. |
| 2 | UTDOA | UTDOA | Um- | Active (designated) | Mobile measurement | Cell ID, Channel and | MMR from SAACH and UTDOA |
| | PDE- | | SACCH | Mobile detected | reports (MMR) | Ciphering information | location derived concurrently by LMU |
| | LMU, | | (LMU) | with CAMEL | obtained from LMU. | sent from SMLC to PDE. | (No GMLC-provided location |
| | SCP, | | | trigger, GMLC | | PDE-provided position | synchronization required). |
| | SMLC | | | queried via Le | | location. | |
| | GMLC | | | | | | |
| 3 | UTDOA | UTDOA | SMLC | Active (designated) | Mobile measurement | SMLC-provided position | Time, method, serving cell and LCS |
| | PDE- | | | Mobile detected | reports (MMR) | location. | client type used to identify SMLC |
| | LMU, | | | with CAMEL | obtained from SMLC. | | transaction providing MMR data plus |
| | SCP, | | | trigger, GMLC | | | location. (No GMLC-provided location |
| | SMLC | | | queried via Le | | | synchronization required). |
| | GMLC | | | | | | |
| 4 | AMU, | AGPS | Abis | Mobile activity | Mobile and BTS | Mobile/SMLC performs | AMU provides Mobile and BTS |
| | SCP, | | (AMU) | within Cell detected | measurement reports | AGPS position location. | synchronized measurement data. |
| | SMLC, | | SMLC | by AMU, GMLC | obtained from AMU. | SMLC-provided position | SMLC MMR data used to synchronize |
| | GMLC | | | queried via Le | | location. | location with AMU measurement data. |
| 5 | SCP, | AGPS | SMLC | Active (designated) | Cell ID and Mobile | MS/SMLC performs | Time, method, serving cell (and |
| | SMLC, | | | Mobile detected | measurement reports | AGPS position location. | potentially LCS client type) used to |
| | GMLC | | | with CAMEL | (MMR) obtained from | SMLC-provided position | identify SMLC transaction providing |
| | | | | trigger, GMLC | SMLC. | location. | MMR data plus location (No GMLC- |
| | | | | queried via Le | | | provided location synchronization |
| | | | | | | | required). |
| 6 | AMU, | EOTD | Abis | Active (designated) | Mobile and BTS | MS/SMLC performs | AMU provides Mobile and BTS |
| | SCP, | | (AMU) | Mobile detected | measurement reports | EOTD position location. | synchronized measurement data. |
| | SMLC, | | GMLC | with CAMEL | obtained from AMU. | GMLC-provided position | AMU detection of MS-BSS EOTD |
| | GMLC | | | trigger, GMLC | | location. | signaling synchronized with Mobile and |
| | | | | queried via Le | | | BTS measurement data and linked to |
| | | | | | | | GMLC-provided location. |
| 7 | SCP, | EOTD | SMLC | Active (designated) | Cell ID and Mobile | MS/SMLC performs | Time, method, serving cell and |
| | SMLC, | | | Mobile detected | measurement reports | EOTD position location. | potentially LCS client type used to |
| | GMLC | | | with CAMEL | (MMR) obtained from | SMLC-provided position | identify SMLC transaction providing |
| | | | | trigger, GMLC | SMLC. | location. | MMR data plus location (No GMLC- |
| | | | | queried via Le | | | provided location synchronization |
| | | | | | | | required). |
| 8 | AMU, | EOTD | Abis | MS activity within | Mobile and BTS | MS/SMLC performs | AMU provides Mobile and BTS |
| | SMLC, | | (AMU) | Cell detected by | measurement reports | EOTD position location. | synchronized measurement data. |
| | GMLC | | SMLC | AMU, GMLC | obtained from AMU. | SMLC-provided position | SMLC MMR data used to synchronize |
| | | | | queried via Le | | location. | location with AMU measurement data. |

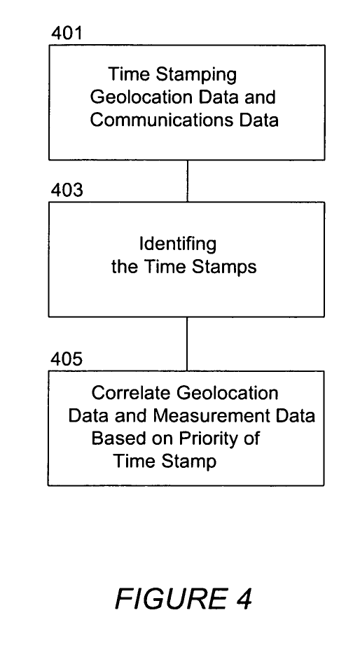

FIG. 4 is a flow chart for generating geocoded data to optimize a network. In block 401, geolocation data as well as wireless communication measurement data associated with active mobiles are time stamped. The time stamps are identified for the geolocation data and the wireless communication measurement data as shown in Block 403. The geolocation data and the wireless communication measurement data are then correlated based on the proximity of the identified time stamps as shown in Block 405. In addition to the time stamps, the data may also be correlated by serving cell of the active mobile, based on the method of geolocation as triggered by the QoS request or LCS client type. These additional characteristics may allow for more distinctions and thus higher confidence correlations. For example, if the correlation of time stamps produces two geolocation data correlations for a single wireless communication measurement data time stamp, further correlation may be required to distinguish the proper correlation. As noted previously, the wireless communication measurement data may include timing advance, SNR, received signal power, transmit signal power as well as Mobile Assisted Hand-Off (“MAHO”) information.

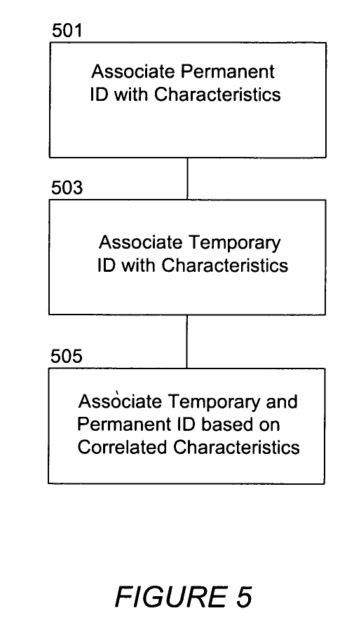

Referring to FIG. 5, a flow chart of a method of generating geocoded data for use in optimizing the network where geolocation data and wireless communication measurement data for an active mobile are determined by separate entities. The separate entities, for example, could be a communication network and a geolocation overlay system. In block 501, the permanent ID of an active mobile is associated with a time stamp or other characteristics. In Block 503, the temporary ID is associated with a time stamp or other characteristics. The characteristics associated with the permanent ID are then correlated with the characteristics associated with the temporary ID to link both the permanent ID and the temporary ID as shown in Block 505. In an alternative embodiment, as a result of the association of the temporary and permanent ID, the AMU enables the wireless communication network to associate a permanent ID used to trigger an explicit mobile-terminated location request with the temporary wireless communication network ID related to measurement data collection. Network security can also be addressed by the association of the permanent and temporary IDs. Further, because of the independent verification of the permanent and/or temporary IDs, embodiments of the present subject matter may also address network security requirements or needs in a system.

The present subject matter described applies equally well to 3G networks as defined in 3GPP documents by substituting the following elements: node B for BTS, Radio Network Controller (“RNC”) for BSC; and by substituting the following interfaces: Iub for Abis, Iupc for Lb, and Iu for A. Other smaller changes will be apparent to one skilled in the art.

The present subject matters described applies to CDMA networks as defined in 3GPP2 documents. In this case IS-41 Wireless Intelligent Network (WIN) takes the place of CAMEL, the SMLC is replaced by a location position determining equipment (“PDE”) and the GMLC is replaced by a Mobile Processing Center (“MPC”). Other smaller changes will be apparent to one skilled in the art.

Using the above described geocoding methods, large amounts of geocoded data for the network can be collected thereby generating a comprehensive, near simultaneous view of operation of the network for wireless carrier purposes. The collected geocoded data can be stored in a database or simple file for batch review, or output on a real time interface to a test and measurement analysis tool or any other application or display method known in the art. The data can also be formatted to match existing industry drive test tool formats so that existing testing and measurement analysis tools can be used.

While preferred embodiments of the present inventive system and method have been described, it is to be understood that the embodiments described are illustrative only and that the scope of the embodiments of the present inventive system and method is to be defined solely by the appended claims when accorded a full range of equivalence, many variations and modifications naturally occurring to those of skill in the art from a perusal hereof.

What we claim is:

1. A method of producing geocoded data for optimization of a wireless communication network wherein the wireless communication network is independent of the geolocation system comprising:
identifying the presence of mobile activity in the wireless communication network;
collecting wireless communication measurement data associated with the mobile activity;
obtaining a geolocation of a mobile associated with the mobile activity;
combining the mobile's geolocation with wireless communications measurement data thereby creating geocoded data; and,
transferring the geocoded data to internal or external processing systems that support the implementation of network optimization for the wireless communication network.

2. The method of claim 1, wherein the step of identifying the presence of mobile activity in the wireless communication network is preformed by an Abis monitoring unit (AMU).

3. The method of claim 1, wherein the collecting of wireless communication measurement data is performed by a LMU with direct access to the SACCH via the air (Um) interface and/or by an AMU with access to the SACCH via the Abis interface.

4. The method of claim 1, wherein the obtaining a geolocation of the mobile and its associated channel assignment is performed by uplink time difference of arrival (UTDOA) position determining equipment (PDE)

5. The method of claim 4, where information regarding the mobile is received by the UTDOA PDE from the AMU.

6. The method of claim 4, wherein combining the mobiles' geolocation and wireless communication measurement data are linked by common data collection/position determination time at an LMU associated with the UTDOA PDE.

7. The method of claim 1, wherein the wireless communication measurement data is selected from the group consisting of timing advance, SNR, received signal power, transmit signal power.

8. The method of claim 1, wherein the optimization is selected from the group consisting of reducing voids in coverage, handoff assistance, transmit power regulation and location of network equipment.

9. The method of claim 1, further comprising time stamping the geolocation measurements and wireless communication measurement data to create geocoded data for network optimization.

10. The method of claim 1, wherein the step of identifying the presence of mobile activity in the wireless communication network comprises an intelligent network trigger of the network for detection of the designated mobile ID.

11. The method of claim 1, wherein the obtaining a geolocation of the mobile is performed by UTDOA PDE

12. The method of claim 11, wherein information regarding the mobile is received by the UTDOA PDE from a SMLC.

13. The method of claim 11, wherein combining the mobiles' geolocation and wireless communication measurement data are linked by common data collection/position determination time at an LMU associated with the UTDOA PDE.

14. The method of claim 1 wherein the collecting of wireless communication measurement data is performed by an interface with a SMLC.

15. The method of claim 1, wherein combining the mobiles' geolocation and wireless communication measurement data are linked by at least one of the group consisting of time, LCS client type, method of calculation and serving cell of the mobile.

16. The method of claim 1 wherein the collecting of wireless communication measurement data is performed by an interface with a SMLC.

17. The method of claim 16, further comprising the receiving Cell identification from the interface with the SMLC.

18. The method of claim 1, wherein the obtaining a geolocation of the mobile is performed by AGPS information received from the mobile.

19. The method of claim 18, wherein combining the mobiles' geolocation and wireless communication measurement data are linked by at least one of the group consisting of time, LCS client type, method of calculation and serving cell of the mobile.

20. The method of claim 1, wherein the obtaining a geolocation of the mobile is performed by downlink time of arrival information received from the mobile.

21. The method of claim 20, wherein combining the mobiles' geolocation and wireless communication measurement data are linked by at least one of the group consisting of time, method of calculation and serving cell of the mobile.

22. In a wireless communication network with a geolocation overlay system, a method of generating geocoded data for use in optimizing the network, wherein geolocation data and wireless communication measurement data for an active mobile are correlated, the improvement comprising identifying a time stamp associated with each of the data and correlating the geolocation data and measurement data based on at least on the proximity of time stamps.

23. The method of claim 22, further comprising correlating the geolocation data and measurement data based on serving cell of the active mobile.

24. The method of claim 23, further comprising correlating the geolocation data and measurement data based on method of geolocation.

25. The method of claim 24, further comprising correlating the geolocation data and measurement data base on location service client type.

26. The method of claim 22, wherein the wireless communication measurement data is selected from the group consisting of timing advance, SNR, received signal power, transmit signal power.

27. The method of claim 22, wherein the optimization is selected from the group consisting of determining holes in coverage, handoff assistance, transmit power regulation and location of network equipment.

28. In a wireless communication network with a geolocation overlay system, a method of generating geocoded data for use in optimizing the network wherein geolocation data and wireless communication measurement data for an active mobile are determined by separate entities, the improvement comprising deriving and associated the permanent ID of the active mobile with the temporary ID being used in the wireless communication network.

29. The method of claim 28, wherein intelligent network triggers allow the wireless communication network to associate a permanent ID that activates a trigger with the temporary wireless communication network ID.

30. The method of claim 28, wherein the information received by the AMU allows the wireless communication network to associate a permanent ID used to trigger an explicit mobile-terminated location request with the temporary wireless communication network ID related to measurement data collection.
